(19) United States
(12) Patent Application Publication
(10) Pub. No.: US 2009/0241749 A1
(43) Pub. Date: Oct. 1, 2009

(54) STAMPING MACHINE

(76) Inventor: Rocky E. Tucker, Allenton, MI (US)

Correspondence Address: BROOKS KUSHMAN P.C., 1000 TOWN CENTER, TWENTY-SECOND FLOOR, SOUTHFIELD, MI, 48075, US

(21) Appl. No.: 12/056,399

(22) Filed: Mar. 27, 2008

(51) Int. Cl. B26D 5/08

(52) U.S. Cl. 83/559

(57) ABSTRACT

A stamping machine for punching parts from a workpiece strip and having a punch and complementary die, a workpiece strip feeder for advancing the workpiece strip between the punch and the die, a punch actuator for forcing the punch through the workpiece strip to shear a part from the workpiece strip, a controller for initiating and synchronizing actuation of the workpiece strip feeder and the punch actuator, and also having a horizontal stacking rail aligned with the die to receive and support parts forced from the die as each expelled part forces previously expelled parts along the horizontal stacking rail, thereby maintaining the alignment of each part and thereby eliminating any need to manually or otherwise realign the parts in preparation of a subsequent assembly.

### BACKGROUND OF THE INVENTION

1. Field of the Invention

This invention relates to a stamping machine for successively punching parts from a continuous workpiece strip and horizontally stacking the parts upon a horizontal stacking rail in an aligned disposition for convenient group removal.

2. Background Art

Stamping machines used for punching parts from sheets or strips of material typically deposit resulting parts into a container. A subsequent assembly of such parts requires additional, and often manual, operations to separate, align and combine the parts.

### SUMMARY OF THE INVENTION

The stamping machine of the present invention includes a punch for punching parts from a workpiece strip. The punch has a punch face peripherally configured in the shape of a desired part. The stamping machine also includes a die, or die button, having a through aperture reflecting the peripheral configuration of the punch face and sized to closely receive the punch. The stamping machine further includes a workpiece strip feeder for incrementally advancing the workpiece strip between and past the punch and the die, a punch actuator for forcing the punch through the workpiece strip and a short distance into the aperture in the die to shear a part from the workpiece strip and force the part into the aperture in the die. Also included is a reel disposed to store and release a workpiece strip as the workpiece strip feeder advances the workpiece strip.

The stamping machine further includes a controller for initiating and synchronizing actuation of the workpiece strip feeder and of the punch actuator and includes a horizontal stacking rail detachably aligned with the die to receive and support parts forced from the die as each expelled part forces previously expelled parts along the horizontal stacking rail. The alignment of each part is thereby maintained, thus eliminating any need to manually or otherwise realign the parts in preparation of their subsequent assembly.

The stamping machine also includes a supporting base, a support bracket secured to the supporting base, a stationary end plate secured to the support bracket, and a die holder secured to the stationary end plate. The die holder has a generally central, through aperture; and a die is secured within the aperture. A driven end plate is slidably connected to and linearly movable toward and away from the stationary end plate by the punch actuator. A hold-down mounting plate is secured to and movable with the driven end plate and has a generally central aperture through which the punch extends. A hold-down plate is secured to and movable with the hold-down mounting plate to hold the workpiece strip against the die in preparation for a punch operation. The hold-down plate has a generally central aperture reflecting the peripheral configuration of the punch face and sized to allow a portion of the punch to pass closely through it. At least one slide bar extends from the stationary end plate, and the driven end plate is slid toward the stationary end plate along the at least one slide bar. The punch actuator is connected to the driven end plate by a rigid ram slide.

The stamping machine further includes a rail support removably connected to the support bracket to support the horizontal stacking rail and readily allow removal of the horizontal stacking rail from the stacking machine to facilitate the transport of punched and aligned parts upon the horizontal stacking rail.

A resilient mechanism extends between the driven end plate and the hold-down mounting plate. The resilient mechanism includes at least one, and preferably a first and a second, compression coil spring, that bias the hold-down mounting plate away from the driven end plate. When the hold-down plate is driven against the workpiece strip and the die, the driven end plate continues in motion, compressing the coil springs, the force of which presses and maintains the workpiece strip against the die as the punch continues in motion, shearing a part from the workpiece strip and forcing the part into the aperture in the die. As the driven end plate and the punch are retracted, the force of the coil springs maintains the hold-down plate in position until the punch is withdrawn so that the punch no longer extends beyond the die to interfere with a subsequent advancement of the workpiece strip. Subsequent parts are punched from the workpiece strip and forced into the die. Newly punched parts force previously punched parts along, and parts ultimately emerge from the opposite side of the die. Emerging parts are then similarly forced along the horizontal stacking rail, where they remain aligned until their removal.

A quick-release punch holder is affixed to a driven end plate and releasably supports the punch. A reel is disposed to store and release a workpiece strip as the workpiece strip feeder advances the latter, and a strip guide is secured to the die holder to guide the workpiece strip closely past the die.

In a preferred embodiment of the stamping machine, the peripheral configuration of the punch face is similar to that of a square-cornered, inverted “U”; and a cross-section of the horizontal stacking rail has an inverted “T” shape to support and maintain alignment of a series of parts.

### BRIEF DESCRIPTION OF THE DRAWINGS

FIG. 1 is a side view of a stamping machine of the present invention;

FIG. 2 is an end view, looking from right to left, of a pair of stamping machines of FIG. 1;

FIG. 3 is a partially broken away, perspective, exploded view, minus a workpiece strip reel, a punch actuator, and a ram slide, of basic components of the stamping machine of FIG. 1;

FIG. 4 is an end view, minus a workpiece strip reel and looking from left to right, of the stamping machines of FIG. 1;

FIG. 5 is an end view, minus a workpiece strip reel and looking from right to left, of the stamping machine of FIG. 1;

FIG. 6 is an enlarged side view, minus a workpiece strip reel, of the stamping machine of FIG. 1 and indicates the directions along which FIGS. 7 and 8 are taken;

FIG. 7 is a view of the stamping machine taken along the lines 7-7 of FIG. 6;

FIG. 8 is a view of the stamping machine taken along the line 8-8 of FIG. 6;

FIG. 9 is a partially broken away and partially sectioned side view of the stamping machine of FIG. 6, shown in an open position;

FIG. 10 is a partially broken away and partially sectioned side view of the stamping machine of FIG. 9, shown in a closed position;

FIG. 11 is a frontal view of a typical part output by the stamping machine; and

FIG. 12 is a block diagram illustrating the functions of the basic elements of the stamping machine.

### DETAILED DESCRIPTION OF THE PREFERRED EMBODIMENTS

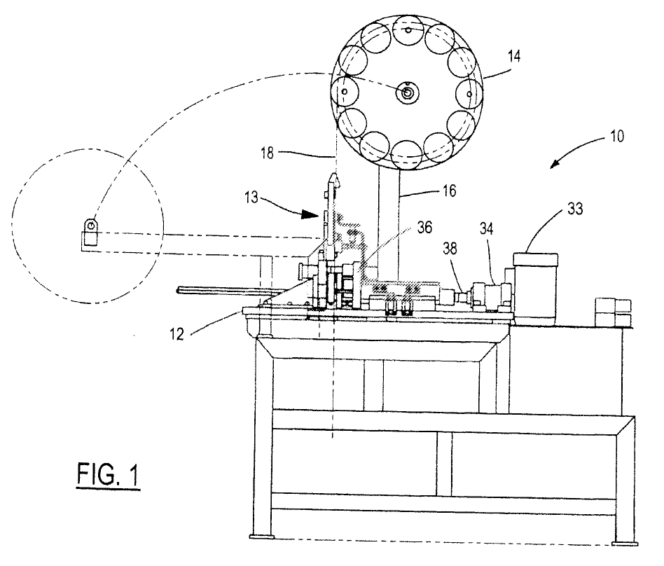

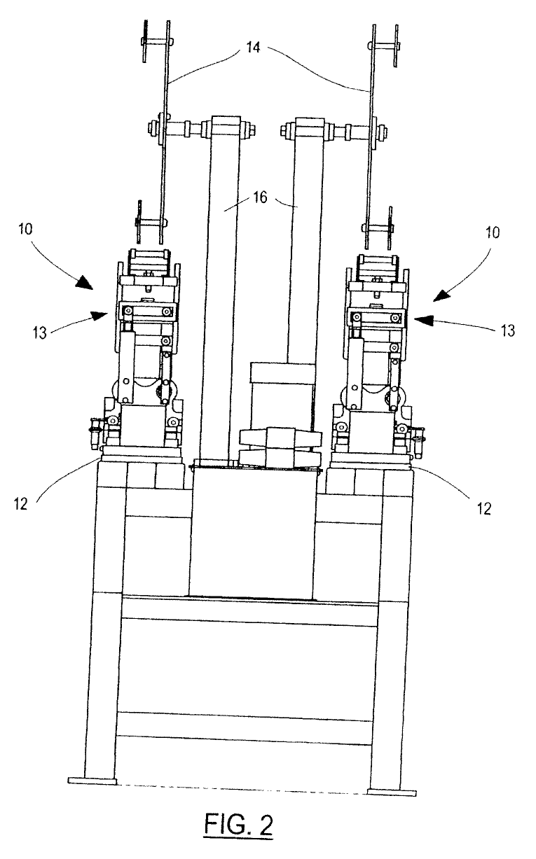

With reference to FIG. 1, a side view of a stamping machine, generally indicated by the reference numeral 10, is shown mounted on a supporting base 12. FIG. 2 is an end view, as viewed from right to left, of a pair of the stamping machines 10 shown by FIG. 1. Shown by FIGS. 1 and 2 are workpiece strip reels 14 mounted on reel supports 16 connected to the supporting base 12. The path of a workpiece strip 17 (FIG. 8) is indicated by phantom lines 18 (FIGS. 1, 6, 9 and 10). As indicated by FIG. 1, a workpiece reel 14 and its support 16 can be tilted to facilitate replacing workpiece strip reels 14 and workpiece strips 17.

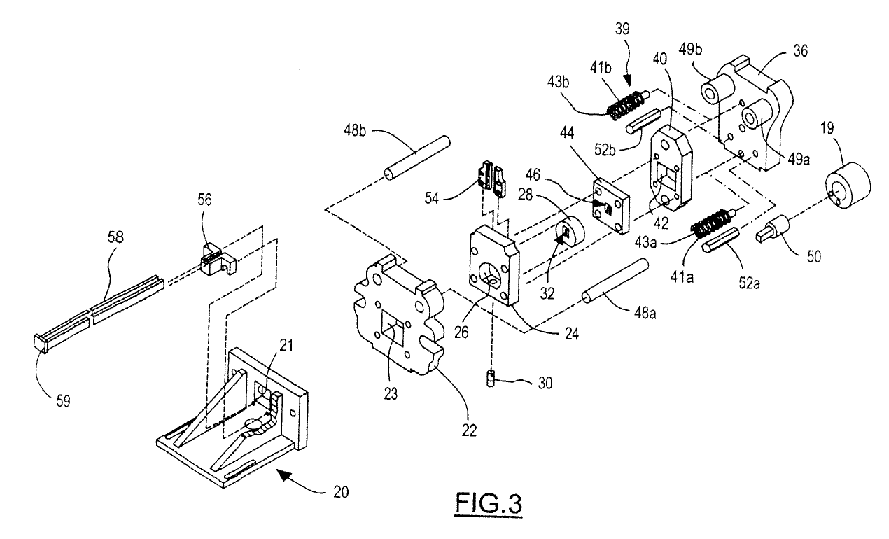

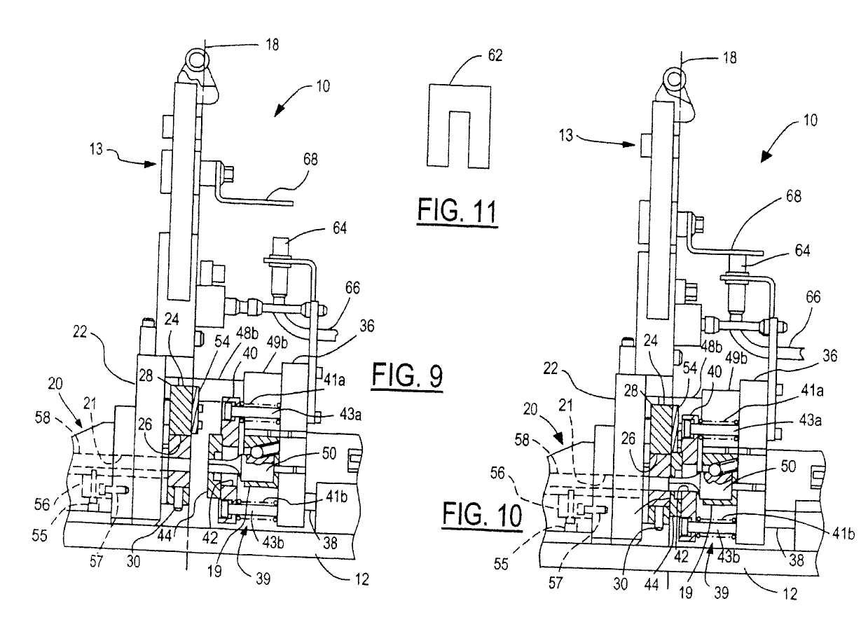

FIG. 3 is a perspective, exploded view of basic components of the stamping machine 10 (FIG. 1). A support bracket, generally indicated by the reference numeral 20, is shown, partially broken away, mounted atop the supporting base 12 (FIG. 1), and a stationary end plate 22 (FIGS. 3 and 9) is secured to the support bracket 20. The support bracket 20 has a generally central aperture 21, and the stationary end plate 22 has a generally central aperture 23. A die holder 24, having a generally central aperture 26, is attached to the stationary end plate 22. A die, or die button, 28 having a generally central aperture, generally indicated by the reference numeral 32, that reflects the peripheral configuration of a punch 50 and is sized to closely receive the punch 50, is secured within the aperture 26 by a die retaining screw 30.

A punch actuator 34 (FIG. 1) is mounted on the supporting base 12 (FIG. 1). As will be understood by one skilled in the art to which the present invention pertains, the punch actuator 34 can be pneumatically, mechanically or, as preferred, hydraulically driven by a compressor 33 (FIG. 1). The punch actuator 34 is connected to a driven end plate 36 by a ram slide 38 (FIG. 1). As shown by FIG. 3, the driven end plate 36 is spaced from and slidably connected to a hold-down mounting plate 40. The hold-down mounting plate 40 has a generally central aperture 42. Extending between the driven end plate 36 and the stationary end plate 22 are first 48a and second 48b slide bars upon which the driven end plate 36 slides toward and away from the stationary end plate 22.

The punch 50 is attached to and extends from the driven end plate 36 through the aperture 42 in the hold-down mounting plate 40 and through an aperture, generally indicated by the reference numeral 46, in a hold-down plate 44 that is releasably attached to the hold-down mounting plate 40. At least one, and preferably two, limiting bars 52a and 52b also extend from the driven end plate 36 toward, but not quite to, the die holder 24. If controls fail, the limiting bars 52a and 52b will halt travel of the driven end plate 36 toward the die holder 24. A strip guide 54 is attached to the die holder 24, above the central aperture 26 to guide the workpiece strip 17 (FIG. 8) closely past the die 28. A rail support 56 is attached with bolts 57 (FIGS. 4 and 9) to the support bracket 20 below the aperture 21. A horizontal stacking rail 58 (FIG. 3), having a cross sectional configuration of an inverted “T,” is supported by the rail support 56 so that it is aligned with the aperture 32 of the die 28. A rail bolt 55 (FIG. 9) releasably secures the horizontal stacking rail 58 to the rail support 56.

FIG. 4 is an end view of the support bracket 20. It shows, through the aperture 21 in the support bracket 20, the die 28. It also shows the horizontal stacking rail 58, the rail support 56 and a part 62 (also shown by FIG. 11) after it has been pushed through the aperture 32 (FIG. 3) of the die 28 onto the horizontal stacking rail 58. As shown by FIG. 3, the horizontal stacking rail 58 is provided with a stop 59 at its distal end to prevent parts 62 (FIG. 11) from falling off the distal end. As will be understood by those skilled in the art to which the present invention pertains, parts having different configurations and dimensions can be produced by the stamping machine 10 of the present invention.

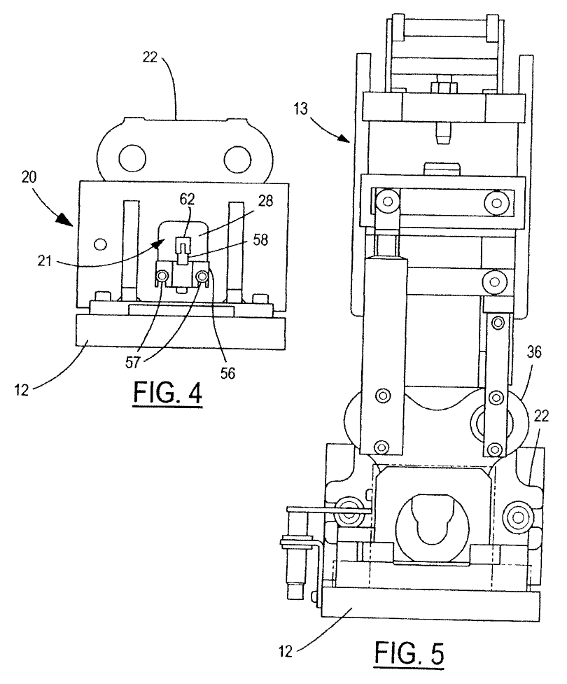

FIG. 5 is an end view, opposite to that of FIG. 4, of the stamping machine 10. FIGS. 5, 6, 9 and 10 indicate the approximate position of a workpiece strip feeder, generally indicated by the reference numeral 13. Details of the workpiece strip feeder 13 are not shown but are known in the art. The preferred workpiece strip feeder 13 includes first and second sets of pneumatically driven claspers (not shown). The first set of claspers advances the workpiece strip 17 (FIG. 8) while the second set of claspers is released, and the second set of claspers immobilizes the workpiece strip 17 while the punch 50 (FIG. 3) is engaged in a shearing operation and while the first set of claspers is being repositioned in preparation for a subsequent advancement of the workpiece strip 17 (FIG. 8).

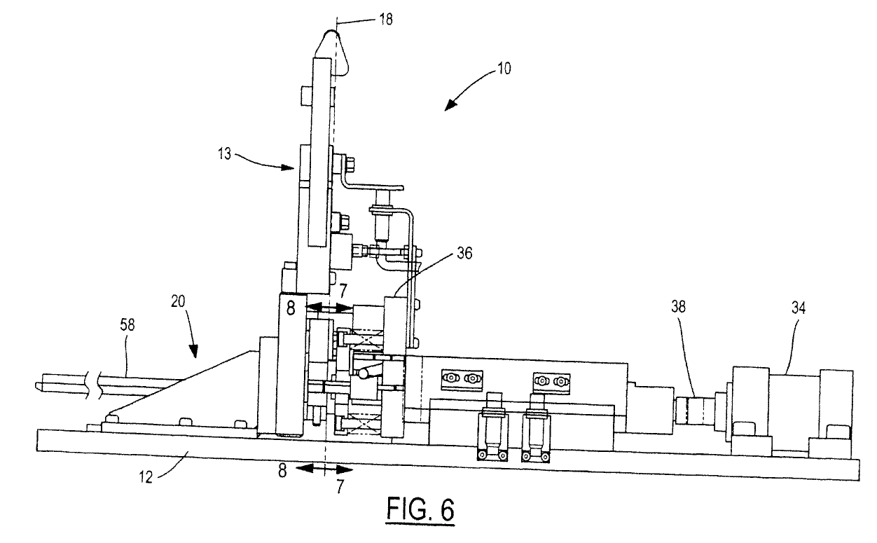

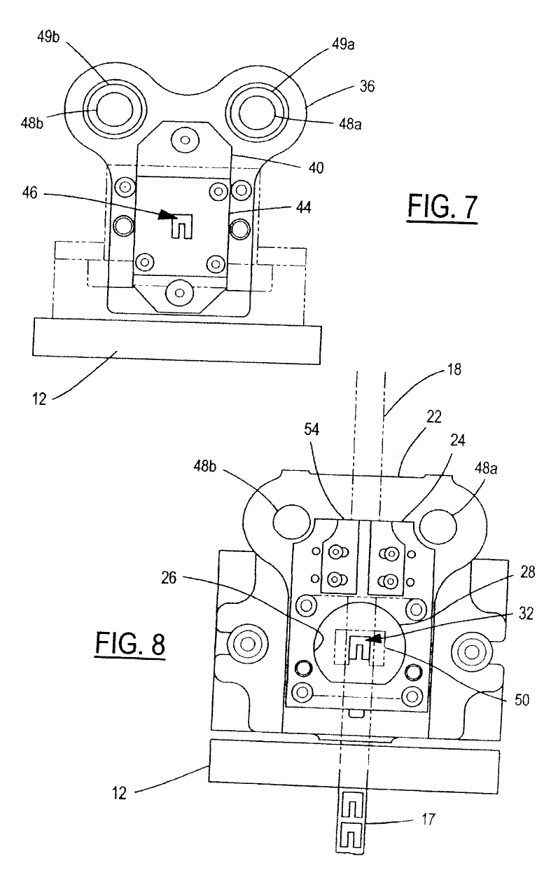

FIG. 6 is an enlarged side view, minus the workpiece strip reel 14 (FIG. 1), of the stamping machine 10 of FIG. 1 and indicates the directions along which FIGS. 7 and 8 are taken. FIG. 7 is a view of the stamping machine taken along the lines 7-7 of FIG. 6 and shows the hold-down mounting plate 40, the hold-down plate 44 and the aperture 46 in the latter. It also shows the slide bars 48a and 48b and slide bar bearings 49a and 49b that slidably secure the slide bars 48a and 48b to the driven end plate 36.

FIG. 8 is a view of the stamping machine taken along the lines 8-8 of FIG. 6 and shows the die 28 and the aperture 32 in the latter. It also shows the slide bars 48a and 48b extending into the stationary end plate 22 and the strip guide 54 mounted on the die holder 24 in the path 18 (shown in phantom lines) of the workpiece strip 17 (FIG. 8) to guide the latter closely past the die 28.

FIG. 9 is a side view of a portion of the stamping machine of FIG. 1, shown partially broken away, partially in section, and in an open position. Shown is the support bracket 20 and the stationary end plate 22 supported by it. The die holder 24 is shown in section supported by the stationary end plate 22, and the die 28 is shown in section secured by the die retaining screw 30 within the aperture 26 of the die holder 24. The driven end plate 36 is shown connected to the ram slide 38. The driven end plate 36 is also spaced from and slidably connected to the hold-down mounting plate 40, which is shown in section. A resilient mechanism, generally indicated by the reference numeral 39, extends between the driven end plate 36 and the hold-down mounting plate 40 and resiliently biases the latter away from the former. The resilient mechanism includes at least one, and preferably two, compression coil springs 41a and 41b (FIGS. 3, 9 and 10). Spring posts 43a and 43b (FIGS. 3, 9 and 10) are axially disposed within compression coil springs 41a and 41b, respectively, and extend from the driven end plate 36 into the hold-down mounting plate 40, where they are slidably retained. The hold-down plate 44 is secured to the hold-down mounting plate 40, the punch 50 is releasably secured to the driven end plate 36 by a known punch holder 19 (FIG. 3), and the strip guide 54 is secured to the die holder 24 to guide the workpiece strip 17 (FIG. 8) closely past the die 28 (FIG. 3). The known punch holder 19 is such that punches of different sizes can be quickly and conveniently exchanged to service or replace similar punches or to produce parts having different configurations and dimensions.

The rail support 56 (shown by dashed lines) is secured to the support bracket 20 with bolts 57 (shown by dashed lines in FIGS. 4 and 9), and the rail 58 (shown in FIGS. 3 and 4 and by dashed lines in FIGS. 9 and 10) is supported by the rail support 56. Slide bar bearings 49a and 49b are supported by the driven end plate 36. A rail bolt 55 (shown by dashed lines) releasably secures the horizontal stacking rail 58 to the rail support 56.

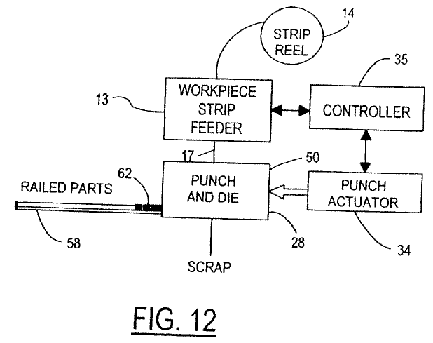

The present invention employs a plurality of various sensors to sense positions and conditions of various components, such as the punch actuator 34 of FIGS. 1 and 6, and such as the workpiece strip feeder, not shown in detail but generally indicated by the reference numeral 13 of FIGS. 1, 2, 5, 6, 9 and 10. Representative of sensors known by those skilled in the art to which the present invention pertains is a proximity sensor 64 (FIG. 9). The proximity sensor 64 communicates a signal representative of the position of a proximity sensor target 68 via a proximity sensor cable 66 to a controller 35 (FIG. 12). The positions, the differences of which are illustrated by FIGS. 9 and 10, respectively, of the proximity sensor target 68 is indicative of the position of the first set of claspers in the workpiece strip feeder 13. In response to receiving sensor signals, the controller 35 (FIG. 12) initiates and synchronizes actuations of the workpiece strip feeder 13 (FIG. 9) and the punch actuator 34 (FIG. 12).

FIG. 10 is a side view of the portion of the stamping machine of FIG. 9 except that the stamping machine is closed, that is, it is in a position where the punch 50 has been pushed through the workpiece strip 17 (FIG. 8) and into the aperture 32 in the die 28, carrying a punched part 62 (FIG. 11) with it.

FIG. 12 is a schematic diagram illustrating the functions of the basic elements of the stamping machine. Shown are schematic representations of the strip reel 14, the workpiece strip 17, the workpiece strip feeder 13, the punch 50 and die 28, the punch actuator 34, and the controller 35. Also shown is the horizontal stacking rail 58 and a representative number of parts 62 stored upon the rail 58.

With reference to FIGS. 1 and 2, operating the stamping machine 10 involves loading the workpiece strip reel 14 onto the support 16 and feeding a leading end of the workpiece strip 17 (FIG. 8) downwardly along the workpiece strip path 18, through the workpiece strip feeder 13, through the strip guide 54 (FIGS. 3 and 9) and past the die 28 and the opposing hold-down plate 44.

Upon receiving a command signal to begin, the controller 35 (FIG. 12) activates the punch actuator 34, which, by way of the ram slide 38 (FIG. 1), forces the driven end plate 36, the hold-down mounting plate 40 (FIGS. 3 and 9), the hold-down plate 44 and the punch 50 in a leftward (FIG. 1) direction, the driven end plate 36 sliding along the slide bars 48a and 48b (FIGS. 3 and 9), until the hold-down plate 44 contacts the workpiece strip 17 (FIG. 8) and forces the workpiece strip 17 against the die 28 (FIGS. 3 and 9). At this point, the hold-down mounting plate 40 and the hold-down plate 44 are stopped. The driven end plate 36 continues to move in a leftward direction, however, compressing the compression coil springs 41a and 41b that extend between the driven end plate 36 and the hold-down mounting plate 40 as the axial spring posts 43a and 43b slide within apertures in the hold-down mounting plate 40. As they are being compressed, the compression coil springs 41a and 41b apply an increasing pressure on the hold-down plate 44 and thus against the workpiece strip 17 (FIG. 8) and the die 28 (FIGS. 3 and 9). The punch 50 is forced through the workpiece strip 17 (FIG. 8), shearing a part 62 (FIG. 11) from the workpiece strip 17 (FIG. 8) and forcing the part 62 (FIG. 11) just inside the aperture 32 (FIGS. 3 and 9) of the die 28.

The controller 35 (FIG. 12) then activates the punch actuator 34 to force the driven end plate 36 (FIGS. 3 and 9) and the punch 50 in a leftward direction. The force of the compressed compression coil springs 41a and 41b (FIGS. 3 and 9) maintains the hold-down plate 44 in position against the workpiece strip 17 (FIG. 8) until the punch 50 (FIGS. 3 and 9) has been withdrawn from the aperture 46 in the hold down plate 44, thus ensuring that the punch 50 will not interfere with a subsequent advancement of the workpiece strip 17 (FIG. 8). As the driven end plate 36 (FIGS. 3 and 9) retreats, the compression coil springs 41a and 41b decompress, and the hold-down mounting plate 40 is subsequently pulled by the axial spring posts 43a and 43b in a rightward (FIG. 1) direction away from the workpiece strip 17 (FIG. 8).

If another part 62 (FIG. 11) is to be produced, the controller 35 (FIG. 12) activates the workpiece strip feeder 13 to advance the workpiece strip 17 by a settable amount to position an unsheared area of the workpiece strip 17 before the aperture 32 (FIG. 3) in the die 28 (FIGS. 3 and 9). Sufficient space is provided between consecutive punch positions to prevent distortion of the workpiece strip 17 (FIG. 8) when a part 62 (FIG. 11) is being punched. The spacing is adjustable to enable, as previously mentioned, the stamping machine 10 to produce parts having different configurations and dimensions.

As previously described, a horizontal stacking rail 58 (FIG. 3) is detachably aligned with the die (28) to receive and support parts 62 (FIG. 11) forced from the die 28 as each expelled part 62 forces previously expelled parts 62 along the horizontal stacking rail 58, thereby maintaining the alignment of each part 62 and thereby eliminating any need to manually or otherwise realign the parts 62 in preparation of a subsequent assembly.

While embodiments of the invention have been illustrated and described, it is not intended that these embodiments illustrate and describe all possible forms of the invention. Rather, the words used in the specification are words of description rather than limitation, and it is to be understood that various changes may be made without departing from the spirit and scope of the invention.

What is claimed is:

1. A stamping machine for punching parts from a workpiece strip, the stamping machine comprising:
a punch having a punch face peripherally configured in the shape of a desired part;
a die having a through aperture reflecting the peripheral configuration of the punch face and sized to closely receive the punch;
a workpiece strip feeder for incrementally advancing the workpiece strip between and past the punch and the die;
a punch actuator for forcing the punch through the workpiece strip and into the aperture in the die to shear a part from the workpiece strip and force the part into the aperture in the die;
a controller for initiating and synchronizing actuation of the workpiece strip feeder and of the punch actuator; and
a horizontal stacking rail detachably aligned with the die to receive and support parts forced from the die as each expelled part forces previously expelled parts along the horizontal stacking rail, thereby maintaining the alignment of each part and thereby eliminate any need to manually or otherwise realign the parts in preparation of a subsequent assembly.

2. The stamping machine of claim 1, further comprising:
a supporting base;
a support bracket secured to the supporting base;
a stationary end plate secured to the support bracket;
a die holder secured to the stationary end plate and having a generally central, through aperture to hold the die;
a driven end plate slidably connected to and linearly movable toward and away from the stationary end plate by the punch actuator;
a hold-down mounting plate secured to and movable with the driven end plate and having a generally central, through aperture through which the punch extends;
a hold-down plate removably secured to and movable with the hold-down mounting plate to hold the workpiece strip against the die in preparation for a punch operation, the hold-down plate having a generally central, through aperture reflecting the peripheral configuration of the punch face and sized to closely allow a portion of the punch to pass through; the hold-down plate being removable from the hold-down mounting plate to enable a convenient exchange of the hold-down plate to match configurations of replacement dies; and
at least one slide bar extending from the stationary end plate and along which the driven end plate is slid toward the stationary end plate.

3. The stamping machine of claim 2, further comprising a rigid ram slide connecting the driven end plate to the punch actuator.

4. The stamping machine of claim 2, further comprising a rail support connected to the support bracket to support the horizontal stacking rail and readily allow removal of the horizontal stacking rail to facilitate the transport of punched and aligned parts en masse while retaining their common orientation.

5. The stamping machine of claim 2, further comprising a resilient mechanism extending between the driven end plate and the hold-down mounting plate, the resilient mechanism being compressed as a result of a continued motion of the driven end plate after the hold-down plate is driven against the workpiece strip and the die, the force exerted by the compressed resilient mechanism thereby forcing, and maintaining, the workpiece strip against the die as the punch continues in motion and shears a part from the workpiece strip, the force also maintaining the hold-down plate in position against the die as the punch is retracted to ensure that the punch no longer extends beyond the die to interfere with a subsequent advancement of the workpiece strip.

6. The stamping machine of claim 5, wherein the resilient mechanism comprises at least one compression coil spring.

7. The stamping machine of claim 2, further comprising:
a reel disposed to store and release a workpiece strip as the workpiece strip feeder advances the workpiece strip; and
a strip guide secured to the die holder to guide the workpiece strip closely past the die.

8. The stamping machine of claim 2, further comprising a quick-release punch holder affixed to the driven end plate and releasably supporting the punch.

9. The stamping machine of claim 2, wherein the peripheral configuration of the punch face is similar to that of a square-cornered, inverted “U”; and a cross-section of the horizontal stacking rail has an inverted “T” shape to support and maintain alignment of a series of parts.
